(19) United States
(12) Patent Application Publication
(10) Pub. No.: US 2009/0266012 A1
(43) Pub. Date: Oct. 29, 2009

(54) HURRICANE SHUTTER SYSTEM

(75) Inventors: Clyde Allen, Columbiaville, MI (US); Nathan Greenway, Attica, MI (US); Brad Kutler, Oxford, MI (US)

Correspondence Address: HOWARD & HOWARD ATTORNEYS PLLC, 450 West Fourth Street, Royal Oak, MI, 48067, US

(73) Assignee: Tapco International Corporation, Wixom, MI (US)

(21) Appl. No.: 12/432,674

(22) Filed: Apr. 29, 2009

Related U.S. Application Data
(60) Provisional application No. 61/048,790, filed on Apr. 29, 2008.

(51) Int. Cl. E06B 3/30; E04C 2/20; E06B 9/00; E04B 1/38

(52) U.S. Cl. 52/202; 52/309.1; 52/846; 52/698

(57) ABSTRACT

A shutter assembly for protecting an opening in a structure. The shutter assembly includes a first shutter and a second shutter. Each of the shutters have an attachment end and a free end and defining a width between the corresponding attachment end and the corresponding free end and each present an outer surface. An impact-resistant sheet is disposed on each outer surface. A plurality of hinges are adapted to pivotally couple each shutter to the structure at the attachment end for allowing the shutter to pivot between an open position and a closed position. A crossbar is sized to span the first shutter and the second shutter and terminate at or before the attachment ends of the shutters. A plurality of studs are disposed in linear alignment across the shutters. The crossbar is adapted to engage the studs for securing the shutters in the closed position.

### RELATED APPLICATION

This application claims the benefit of U.S. Provisional Patent Application No. 61/048,790, filed on Apr. 29, 2008, which is hereby incorporated by reference in its entirety.

### FIELD OF THE INVENTION

The subject invention generally relates to a shutter assembly. More specifically, the subject invention relates to a shutter assembly for protecting an opening in a structure during inclement weather.

### BACKGROUND OF THE INVENTION

Shutters generally are either functional or decorative. The decorative shutters are fastened directly to an exterior wall adjacent a window and are merely for aesthetic purposes. Functional shutters are generally movable between an open position and a closed position. In the closed position, the shutters function to protect the windows during inclement weather, such as precipitation storms, wind storms, and hurricanes.

During such inclement weather, it is desirable to lock the shutters in the closed position such that the shutters can continue to provide adequate protection to the windows throughout the inclement weather. If the weather causes the shutters to open then the functional purpose of the shutters is defeated.

The conventional locking systems disclosed in the prior art do not adequately retain the shutters in the closed position throughout the inclement weather. If the wind or storm cause the locking systems to bend or break, the shutters will open, exposing the window to the inclement weather.

Conventional locking systems are secured, typically screwed, directly into the structure on each side of the closed shutters to prevent the shutters from opening during the inclement weather. Installation of many of these conventional locking systems onto the structure is cumbersome and usually requires more than one person or the use of a specialized tool.

Due to the deficiencies in the locking systems of the prior art, including those described above, it is desirable to provide a locking system for shutters that is easy to install, and adequately retains the shutters in a closed position such that protection to the window is maximized throughout any inclement weather.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a perspective view of a structure illustrating a pair of shutters in an open position and a pair of shutters in a closed position having crossbars secure the shutters in the closed position.

FIG. 2 is an elevational view of a pair of shutters in the closed position viewed from inside the structure.

FIG. 3 is an elevational view of a pair of shutters in the closed position viewed from outside the structure.

FIG. 4 is a side view of a shutter assembly.

FIG. 5 is a partially exploded isometric view of a shutter assembly.

### DETAILED DESCRIPTION OF THE PREFERRED EMBODIMENT

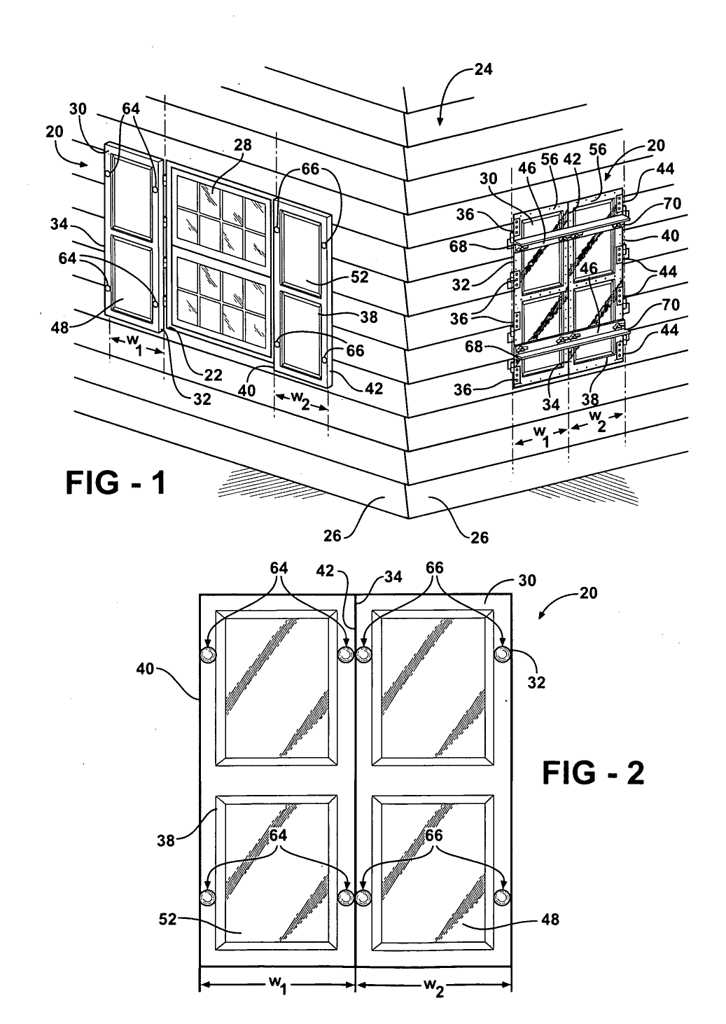

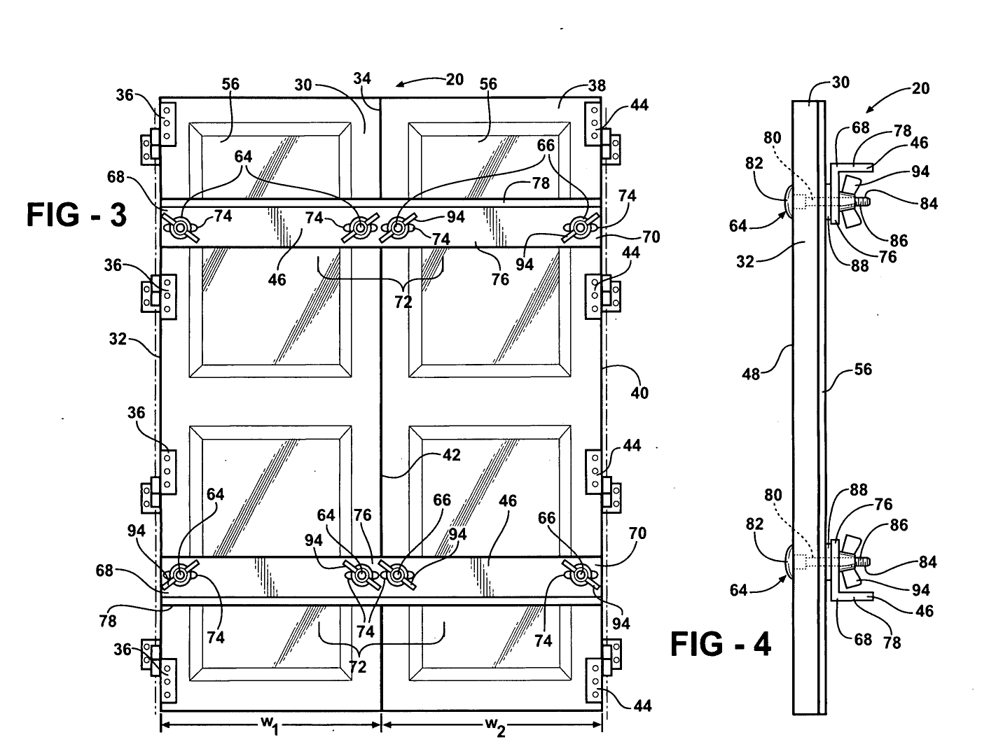

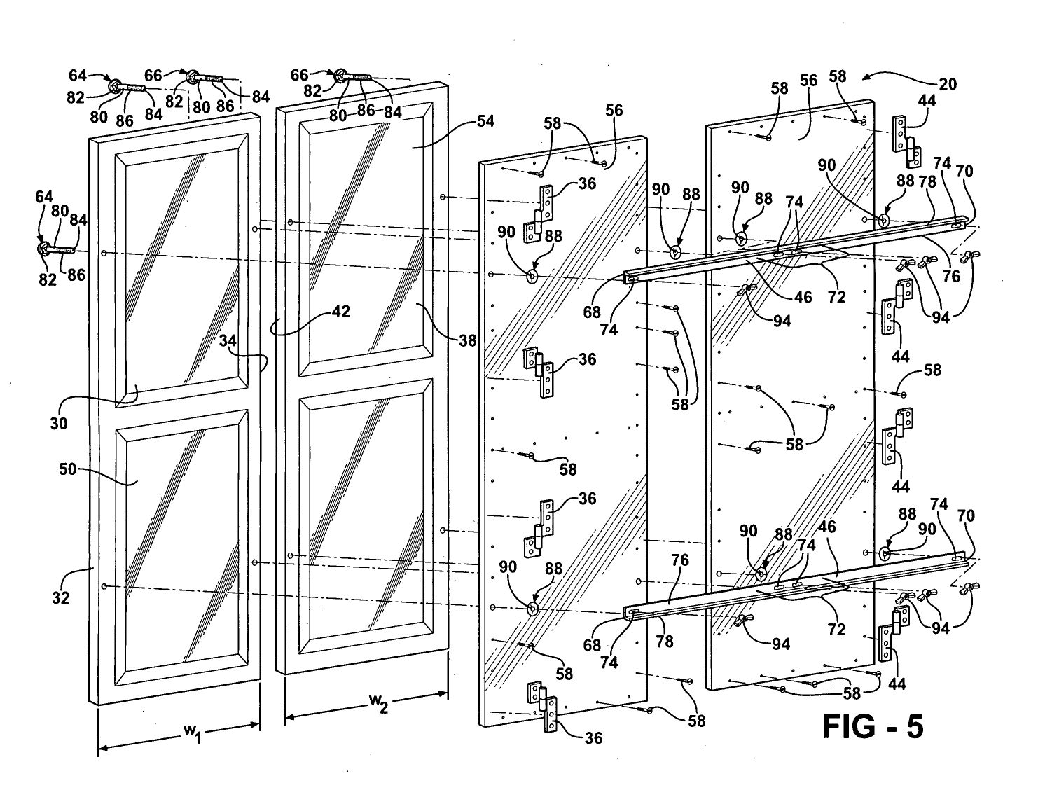

Referring to the Figures, wherein like numerals indicate like or corresponding parts throughout the several views, a shutter assembly is generally shown at 20. As best shown in FIG. 1, the shutter assembly 20 of the present invention is typically used to protect an opening 22 in a structure 24 during inclement weather. The structure 24 includes at least one wall 26 defining the opening 22. A window 28 is typically disposed within the opening 22. The shutter assembly 20 covers the opening 22 defined in the wall 26 to protect the window 28.

The shutter assembly 20 comprises a first shutter 30 having a first attachment end 32 and a first free end 34. The first shutter 30 defines a first width W₁ between the first attachment end 32 and the first free end 34. The first shutter 30 presents a first inner surface 48 which faces the interior of the structure when the first shutter 30 is in a closed position. Similarly, the first shutter presents a first outer surface 50 which faces the exterior of the structure when the first shutter 30 is in an open position. A first plurality of hinges 36 are disposed on the first attachment end 32 and are adapted to pivotally couple the first shutter 30 to the structure 24. The first plurality of hinges 36 allow the first shutter 30 to pivot between the open position and the closed position. The open position is defined as when the first shutter 30 is not covering the opening 22. The closed position is defined as when the first shutter 30 partially covers the opening 22 in the structure 24.

The shutter assembly 20 further comprises a second shutter 38 having a second attachment end 40 and a second free end 42. The second shutter 38 defines a second width W₂ between the second attachment end 40 and the second free end 42. The second shutter 38 presents a second inner surface 52 which faces the interior of the structure when the second shutter 38 is in the closed position. Similarly, the second shutter presents a second outer surface 54 which faces the exterior of the structure when the second shutter 38 is in the open position. A second plurality of hinges 44 are disposed on the second attachment end 40 and are adapted to pivotally couple the second shutter 38 to the structure 24. The second plurality of hinges 44 allow the second shutter 38 to pivot between the open position and the closed position. Similar to the first shutter 30, the open position is defined as when the second shutter 38 is not covering the opening 22. The closed position is defined as when the second shutter 38 partially covers the opening 22 in the structure 24.

Each of the shutters 30, 38 comprise a rigid material such as wood, fiberglass, composite material or any other suitable material known in the art. The present invention may be practiced on a variety of shutter designs, including but not limited to raised panel, louver, or board and batten styles.

The shutter assembly 20 further comprises a plurality of sheets 56 disposed on the outer surfaces 50, 54 of each of the shutters 30, 38. The sheets 56 define shapes that are complementary in configuration to the outer surfaces 50, 54 of the shutters 30, 38 that the sheets 56 will be disposed upon. In other words, the sheets 56 are sized such that the sheets 56 substantially cover the entire outer surface 50, 54 of the shutter 30, 38 but do not extend beyond the perimeter of the shutter 30, 38. The sheets 56 improve the impact resistance of the shutters 30,38 such that the shutter assembly 20 meets the requirements of the Large Missile Impact Test as defined by ASTM E 1886-05 and ASTM E 1996-05 as specified in the International Residential Code (IRC) and the International Building Code (IBC) 2006. The Large Missile Impact Test consists of mounting a test specimen, the shutter assembly 20, in a test fixture. A piece of 2×4 dimensional lumber (the missile) is launched at specified locations on the test specimen at a specified velocity and the results of the impact are recorded. This is a pass/fail type of test to determine if the test specimen is able to withstand conditions specified in the testing specification. A rating is determined for the specimen's impact resistance based on the amount of damage sustained through the testing. Sample Impact Test Results are provided below (references in the Test Results to panels corresponds to the first and second shutters 30, 38 each with the sheets 56 disposed thereon). Although the Test Notes on the Impact Test Results state that the “Shutter cracked at impact locations, top corner impacts bent hinge” the shutter assembly still satisfied the ASTM specification by preventing penetration.

Impact Test Results

| | Missile | Missile | X | Y |
|---|---|---|---|---|
| | Speed | Orientation | Measurement | Measurement |
| Impact Location Specimens 1-3 | (ft/sec) | (deg.) | (in.) | (in.) |
| Center of right panel | 50.3 | 2.7 | 45 | 52 |
| Upper right corner of right panel | 50.1 | 2.8 | 54 | 7 |
| Lower left corner of right panel | 50.3 | 2.5 | 37½ | 96 |
| Center of right panel | 49.5 | 2.5 | 46 | 49 |
| Upper corner of right panel | 50.5 | 2.2 | 54 | 8 |
| Center of right panel | 50.5 | 2.6 | 46½ | 50½ |
| Mid-span of bottom brace | 50.3 | 2.8 | 32¼ | 77 |

Test Notes for Impact Tests

| | |
|---|---|
| 1. | All three specimens were of identical construction. |
| 2. | The X measurement is from the left edge of the specimen. |
| 3. | The Y measurement is from the top edge of the specimen. |
| 4. | The large missile used was a piece of #2 southern yellow pine 2 × 4 |
| | dimensional lumber 92 inches long and weighing 9.0 lbs. |
| 5. | The specimens were conditioned in an environment with temperature |
| | between 65 and 75 degrees F. for at least 48 hr prior to testing. |
| 6. | Shutter cracked at impact locations, top corner impact bent hinge. |
| 7. | Wind Zone 4 definition per ASTM E1996-05b. Section 6.2.2.4 Wind |
| | Zone 4-basic wind speed >140 mph (63 m/s). |

Summary of Results

| | |
|---|---|
| Missile level resisted | D |
| Nominal missile speed resisted | 15.25 m/sec (50 ft/sec) |
| Wind zone achieved | 4 |

The sheets 56 are secured to each of the shutters 30, 38 with fasteners 58, such as screws, rivets, or any other appropriate fastener, including appropriate adhesives. The sheets 56 preferably comprise an impact-resistant material such as polycarbonate or any other suitable material known in the art. Additionally, the sheets 56 are preferably transparent so as to not diminish the aesthetic quality of the shutters 30, 38 when viewed in the closed position. The sheets 56 preferably have a thickness of about 0.125 inches or greater, most preferably 0.125 inches. In some embodiments, the sheets 56 may be thicker or thinner and may be from about 0.03 to about 0.5 inches.

A crossbar 46 spans the first and second shutters 30, 38 on the outside of each of the sheets 56 when each of the shutters 30, 38 are in the closed position. The crossbar 46 has a length that is equal to or less than the sum of the first width W₁ and the second width W₂. In other words, the crossbar 46 terminates at or before each of the first attachment end 32 and second attachment end 40 when the shutters 30, 38 are in the closed position. Thus, the length of the crossbar 46 may also account for any gaps between the shutters 30, 38 when in the closed position. The crossbar 46 will be discussed in greater detail below.

A first plurality of studs 64 are disposed through the first shutter 30 and through the sheets 56. A second plurality of studs 66 are disposed through the second shutter 38 and through the sheets 56 and are linearly aligned with the first plurality of studs 64. The crossbar 46 is adapted to engage the first and second plurality of studs 64, 66 for securing the shutter assembly 20 in the closed position.

The crossbar 46 includes a first end 68 and a second end 70 spaced from the first end 68. The crossbar 46 includes a central portion 72 disposed between the first end 68 and the second end 70. The crossbar 46 defines a plurality of apertures 74. Two of the apertures 74 are elongated slots defined slightly inboard of the ends 68, 70. Two of the apertures 74 are elongated slots defined in central portion 72. The location of the apertures 74 generally corresponds to the first and second plurality of studs 64, 66. The crossbar 46 has a fastening portion 76 in which the plurality of apertures 74 are defined and which accepts the studs 64, 66 there through. Additionally, the crossbar 46 includes a stiffening member 78 disposed substantially perpendicular to the fastening portion 76 for providing rigidity and strength to the crossbar 46. The crossbar 46 has a generally L-shaped configuration and is preferably formed of metal such as aluminum or steel or the like with the fastening portion 76 being one leg of the L-shape and the stiffening member 78 forming the other leg of the L-shape. However, it should be appreciated that any other appropriate configuration may be utilized without deviating from the subject invention.

The studs 64, 66 each include a shaft portion 80 for engaging each of the shutters 30, 38 and the sheets 56, wherein each shaft portion 80 defines a primary diameter. A head portion 82 is disposed on the shaft for abutting the shutters 30, 38 and not allowing the studs 64, 66 to pass through, thereby creating a positive stop feature. Each of the studs 64, 66 further includes a tip portion 84 disposed on the shaft portion 80 opposite the head portion 82. The tip portion 84 presents a plurality of threads 86 adapted to protrude from each of the first shutter 30 and the second shutter 38 and the sheets 56 disposed on each of the shutters 30,38. The studs 64, 66 are preferably carriage bolts. It is to be appreciated that any other suitable stud may be utilized without deviating from the subject invention.

A plurality of retaining rings 88 are disposed over each of the studs 64, 66 for holding the studs 64, 66 substantially perpendicular to each of the shutters 30, 38 and the sheets 56. Each of the retaining rings 88 defines a hole 90 having a secondary diameter slightly smaller than the primary diameter of the shaft portion 80 of the studs 64, 66. A plurality of slots extend radially from the hole 90 defined by each of the retaining rings 88 for allowing the retaining rings 88 to be pressed over the tip portion 84 of the studs 64, 66 and against the sheets 56 to restrict removal of the studs 64, 66.

A plurality of threaded fasteners 94 are adapted to mate with the tip portion 84 of each of the studs 64, 66. When the shutters 30, 38 are in the closed position and the crossbar 46 engages the studs 64, 66, each of the threaded fasteners 94 mate with the studs 64, 66 for securing the crossbar 46 over the shutters 30, 38 and the sheets 56 for locking the shutter assembly 20 into the closed position. A wing nut style fastener is preferably used. However, other types of fasteners, such as hex nuts, clips, or any other appropriate fastener known in the art may be used without deviating from the subject invention.

Additional crossbars 46 may be utilized if required to secure larger shutters in the closed position. Typically, two crossbars 46 will be required for many applications, but it should be appreciated that any number of crossbars 46 may be employed without deviating from the subject invention. If more than one crossbar 46 is utilized, the crossbars 46 will typically be spaced and substantially parallel to each other.

As described above, the studs 64, 66 are held in place within each of the shutters 30, 38 and the sheets 56. The shutters 30, 38 are pivoted to the closed position and the crossbar 46 is placed over the tip portion 84 of the studs 64, 66 extending through the shutters 30, 38 and the sheets 56. The threaded fasteners 94 are tightened to secure the crossbar 46 in place, thereby locking the shutter assembly 20 in the closed position. The shutter assembly 20 can be quickly and easily secured in the closed position by an individual without any type of specialized tools.

The invention has been described in an illustrative manner, and it is to be understood that the terminology which has been used is intended to be in the nature of words of description rather than of limitation. Obviously, many modifications and variations of the present invention are possible in light of the above teachings. It is, therefore, to be understood that reference numerals are merely for convenience and are not to be in any way limiting, the invention may be practiced otherwise than as specifically described.

What is claimed is:

1. A shutter assembly for protecting an opening in a structure, said shutter assembly comprising:
a first shutter having a first attachment end and a first free end defining a first width between said first attachment end and said first free end;
a first plurality of hinges adapted to pivotally couple said first shutter to the structure at said first attachment end and allowing said first shutter to pivot between an open position and a closed position;
a first plurality of studs;
a second shutter having a second attachment end and a second free end defining a second width between said second attachment end and said second free end;
a second plurality of hinges adapted to pivotally couple said second shutter to the structure at said second attachment end and allowing said second shutter to pivot between an open position and a closed position;
a second plurality of studs; and
a crossbar sized to span said first shutter and said second shutter and terminate at or before said first attachment end and said second attachment end said crossbar adapted to engage said first and second plurality of studs for securing said shutters in said closed position.

2. The shutter assembly as set forth in claim 1 wherein said shutters present and inner surface facing the interior of the structure and an outer surface facing the exterior of the structure when each of said shutters are in said closed position.

3. The shutter assembly as set forth in claim 2 further including a thermoplastic polymeric sheet disposed on said outer surface of each of said shutters.

4. The shutter assembly as set forth in claim 3 wherein said thermoplastic polymeric sheet comprises a thickness of from about 0.03 inches to 0.5 inches.

5. The shutter assembly as set forth in claim 1 wherein said crossbar has a length equal to or less than a sum of said first width and said second width of said shutters.

6. The shutter assembly as set forth in claim 5 wherein said crossbar has a first end and a second end spaced from said first end and a central portion disposed between said first end and said second end, wherein said crossbar defines a plurality of apertures, spaced from each of said ends and about said central portion corresponding to said apertures defined by said frame.

7. The shutter assembly as set forth in claim 6 wherein said crossbar includes a fastening portion defining said plurality of apertures and a stiffening member substantially perpendicular to said fastening portion for providing rigidity and strength to said crossbar.

8. The shutter assembly as set forth in claim 7 wherein said cross bar defines a cross section having a substantially L-shaped configuration.

9. The shutter assembly as set forth in claim 8 wherein each of said studs include a shaft portion defining a primary diameter and engaging each of said shutters and a head portion disposed on said shaft for abutting said shutter and not allowing said stud to pass through said shutter thereby providing a positive stop feature, said studs further include a tip portion disposed on said shaft opposite said head portion wherein said tip portion presents a plurality of threads adapted to protrude from each of said first shutter and said second shutter.

10. The shutter assembly as set forth in claim 9 further includes a plurality of retaining rings wherein each of said retaining rings defines a hole including a plurality of slots radially projecting there from wherein said hole has a secondary diameter slightly smaller than said primary diameter of said studs for engaging said studs and securing said studs through and substantially perpendicular to each of said first shutter and said second shutter.

11. The shutter assembly as set forth in claim 10 further including a plurality of threaded fasteners for mating with said tip portion of said studs for securing said crossbar over said first shutter and said second shutter when in said closed position.

12. The shutter assembly as set forth in claim 11 including a second crossbar sized to span said first shutter and said second shutter and terminate at or before said first attachment end and said second attachment end for securing said shutters in said closed position.

13. The shutter assembly as set forth in claim 12 wherein said crossbars are substantially parallel to one another.

14. The shutter assembly as set forth in claim 13 wherein said crossbars are spaced from one another.

15. A shutter assembly for protecting an opening in a structure, said shutter assembly comprising:
a first shutter having a first attachment end and a first free end defining a first width between said first attachment end and said first free end and presents a first outer surface;
a first plurality of hinges adapted to pivotally couple said first shutter to the structure at said first attachment end and allowing said first shutter to pivot between an open position and a closed position;
a first plurality of studs;
a second shutter having a second attachment end and a second free end defining a second width between said second attachment end and said second free end and presents a second outer surface;
a second plurality of hinges adapted to pivotally couple said second shutter to the structure at said second attachment end and allowing said second shutter to pivot between an open position and a closed position;
a second plurality of studs;
a crossbar sized to span said first shutter and said second shutter and terminate at or before said first attachment end and said second attachment end said crossbar adapted to engage said first and second plurality of studs for securing said shutters in said closed position;
and a sheet formed of impacted resistant material and disposed on each of said first and second outer surfaces for providing improved impact resistance to said first and second shutters.

16. The shutter assembly as set forth in claim 15 wherein said impact resistant material is preferably a thermoplastic polymeric sheet.

17. The shutter assembly as set forth in claim 16 wherein said impact resistant material is preferably polycarbonate.
